(19) United States
(12) Patent Application Publication
(10) Pub. No.: US 2024/0370795 A1
(43) Pub. Date: Nov. 7, 2024

(54) INFORMATION PROCESSING APPARATUS

(71) Applicant: TOYOTA JIDOSHA KABUSHIKI KAISHA, Aichi-ken (JP)

(72) Inventors: Daichi YAMASHITA, Tokyo (JP); Kenta TAKESHIMA, Tokyo (JP); Nobuhisa OTSUKI, Tokyo (JP); Yusuke KIDA, Tokyo (JP); Hideo HASEGAWA, Tokyo (JP)

(21) Appl. No.: 18/650,086

(22) Filed: Apr. 30, 2024

(30) Foreign Application Priority Data
May 1, 2023 (JP) 2023-075447

(51) Int. Cl. G06Q 10/0631; G06Q 10/02

(52) U.S. Cl. CPC G06Q 10/06312; G06Q 10/02

(57) ABSTRACT

An information processing apparatus comprises a controller, the controller comprising at least one processor configured to perform: acquiring position information about a first user, the user having been absent from a predetermined event at an event holding timing, which is a date and time of the predetermined event having been held; acquiring first information that is information at the event holding timing different from the position information about the first user and is information related to the first user at the event holding timing; determining whether a reason for the first user having been absent from the predetermined event is a force majeure reason or not based on the position information and the first information; and selecting the first user as a follow-up target if the absence reason is determined to be a force majeure reason.

### CROSS REFERENCE TO THE RELATED APPLICATION

This application claims the benefit of Japanese Patent Application No. 2023-075447, filed on May 1, 2023, which is hereby incorporated by reference herein in its entirety.

### BACKGROUND

### Technical Field

The present disclosure relates to analysis of a user's behavior.

### Description of the Related Art

There are known many techniques for analyzing a user's behavior or attributes.

With regard thereto, for example, Japanese Patent No. 6494837 discloses a cluster generation apparatus and the like for extracting a plurality of users from attribute information about users and behavior history information and the like about the users, and based on information about the extracted users, generating a cluster that includes attribute information, behavior history information or the like about the users.

### SUMMARY

An object of the present disclosure is to follow up an absentee from an event.

One aspect of an embodiment of the present disclosure is an information processing apparatus comprising a controller, the controller comprising at least one processor configured to perform:
acquiring position information about a first user, the user having been absent from a predetermined event at an event holding timing, which is a date and time of the predetermined event having been held;
acquiring first information that is information at the event holding timing different from the position information about the first user and is information related to the first user at the event holding timing;
determining whether a reason for the first user having been absent from the predetermined event is a force majeure reason or not based on the position information and the first information; and
selecting the first user as a follow-up target if the absence reason is determined to be a force majeure reason.

As another aspect, a method performed by the above apparatus, a program for causing a computer to perform the method, and a computer-readable storage medium in which the program is non-transitorily stored can be given.

According to the present disclosure, it is possible to follow up an absentee from an event.

### BRIEF DESCRIPTION OF THE DRAWINGS

FIG. 1 is a conceptual diagram of a process performed by an information processing apparatus;

FIG. 2 is a diagram illustrating components included in a system, the system including the information processing apparatus according to an embodiment;

FIG. 3 is a flowchart of a process performed by a controller of the information processing apparatus according to the embodiment;

FIG. 4 is a flowchart of a process for making a determination on an absence reason based on health information, which is performed by the controller of the information processing apparatus according to the embodiment; and

FIG. 5 is a flowchart of a process for making a determination on an absence reason based on traffic information, which is performed by the controller of the information processing apparatus according to the embodiment.

### DESCRIPTION OF THE EMBODIMENTS

There is known an inventor apparatus that notifies users of a predetermined event being held and invites the users to the event.

Consideration will be made, for example, on a case of inviting any users when a predetermined event is held. For example, based on attribute information and the like about users, the inventor apparatus can transmit an event holding notification to users to be a target group of the predetermined event. Or alternatively, the inventor apparatus can accept participation applications from users who have known the holding of the event.

There may be, however, a case where the user is absent on the day of the event. For example, a case may happen where, though the user is much interested in the event, he/she has to be absent from the event on the day of the event due to force majeure.

In that case, since the user can be a future potential customer, it is favorable that the inventor apparatus follows up the user after that. Therefore, conventionally, it has been performed to transmit a notification asking for an answer about the reason for absence to each user who was absent on the day of an event. The answer, however, is voluntarily given by each user, the answer may not be obtained.

In such a case, it is desirable to, in order to grasp whether the user is still interested in the event irrespective of the absence, be able to accurately grasp the reason for the absence of the user without depending on the user's voluntary answer.

In the present disclosure, by determining a reason for a user having been absent from an event, based on various kinds of information about the user at the date and time when the user was absent from the event, the above problem is solved.

The present disclosure in its one (another) aspect provides an information processing apparatus comprising a controller, the controller comprising at least one processor configured to perform:
acquiring position information about a first user, the user having been absent from a predetermined event at an event holding timing, which is a date and time of the predetermined event having been held;
acquiring first information that is information at the event holding timing different from the position information about the first user and is information related to the first user at the event holding timing;
determining whether a reason for the first user having been absent from the predetermined event is a force majeure reason or not based on the position information and the first information; and
selecting the first user as a follow-up target if the absence reason is determined to be a force majeure reason.

The predetermined event is an event the holding of which is notified by an inventor server, the event server being an apparatus for notifying users that an event is to be held. The event may be a lecture-type or participation-type event viewed by a plurality of participants, for which the date and time is decided. The predetermined event may be held online or at site.

The event holding timing is a date and time when the predetermined event is held. The event holding timing may be time to start the predetermined event or may be a period during which the event is held.

The controller acquires the position information about the first user having been absent from the predetermined event, and the first information related to the first user other than the position information, at the event holding timing, which is the date and time of the predetermined event having been held.

Then, the controller determines whether the reason for the first user having been absent from the predetermined event is a force majeure reason or not, based on the position information and the first information, and selects the first user as a follow-up target if the absence reason is determined to be a force majeure reason.

The follow-up may be transmission of additional information about the predetermined event. For example, the follow-up may be transmission of information about events that are the same as or similar to the predetermined event, to the first user.

Thereby, the information processing apparatus can accurately determine the reason for the first user having been absent from the predetermined event. Further, if the absence reason is a force majeure reason, it can be determined that the first user can be a potential customer. Then, the information processing apparatus can continue to transmit event information to the first user that can be a potential customer. Thus, the information processing apparatus can appropriately take care of such a user that can be a potential customer.

The controller may notify an inventor that the first user has been selected as a follow-up target, the inventor being an apparatus for inviting a plurality of users to the predetermined event.

Thereby, the information processing apparatus can provide information about a user to be followed up, who can be a potential customer, for the inventor.

Further, the first information may include at least any of: (i) health information indicating a health condition of the first user at the event holding timing; (ii) traffic information indicating a traffic situation on a route from a position of the first user to a venue of the predetermined event at the event holding timing; (iii) weather information indicating a weather situation around the position of the first user at the event holding timing; and (iv) schedule information about a schedule of the first user at the event holding timing.

Thereby, the information processing apparatus can acquire information about a factor that causes the reason for absence from an event to be a force majeure reason, such as a health condition, a traffic situation, weather, or an immediately previous schedule. Therefore, the information processing apparatus can appropriately determine whether the reason for absence from the event is a force majeure reason or not.

Further, if the first information includes (i) the health information indicating the health condition of the first user at the event holding timing, the position of the first user is at a home of the first user or in any hospital at the event holding timing, and the health condition of the first user is lower than a predetermined level, then the controller may determine that the reason for the first user having been absent from the predetermined event is a force majeure reason.

Thereby, for a case where it is thought that the reason for the first user having been absent from the predetermined event is sickness, the information processing apparatus can determine that the absence reason is a force majeure reason.

Further, if the first information includes (ii) the traffic information at the event holding timing, and the traffic situation on the route from the position of the first user to the venue of the predetermined event is such a situation that it is difficult for the first user to move to the venue at the event holding timing, then the controller may determine that the reason for the first user having been absent from the predetermined event is a force majeure reason.

Thereby, for a case where it is thought that the reason for the first user having been absent from the predetermined event is a traffic situation, the information processing apparatus can determine that the absence reason is a force majeure reason.

Hereinafter, a specific embodiment of the present disclosure will be described based on drawings. A hardware configuration, a module configuration, a functional configuration and the like described in an embodiment are not intended to limit the technical scope of the disclosure only thereto unless otherwise described.

### Embodiment

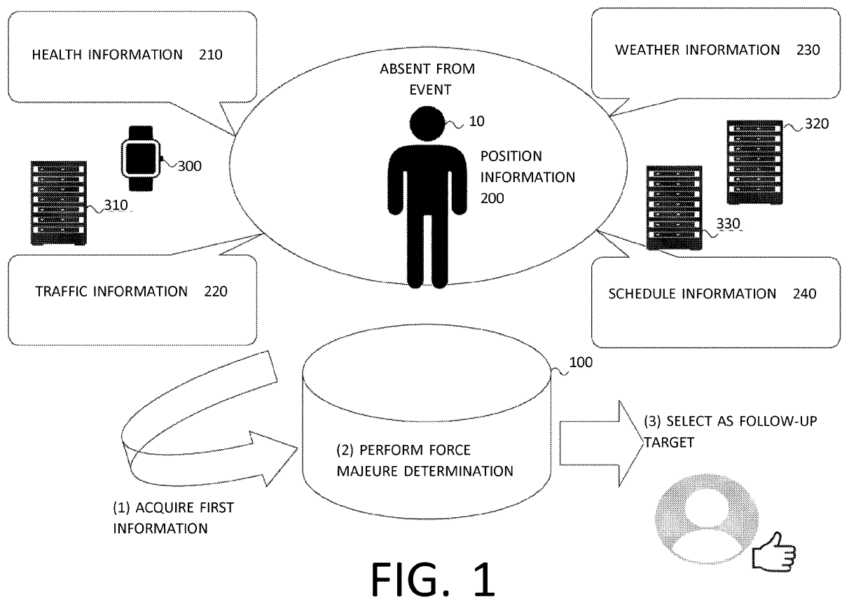

An overview of a process performed by an information processing apparatus according to an embodiment will be described with reference to FIG. 1. FIG. 1 is a conceptual diagram of a process performed by an information processing apparatus 100. In the present embodiment, the information processing apparatus 100 acquires position information about a first user 10, and first information that includes at least one of a plurality of kinds of information, which is information about the first user 10.

In the present embodiment, an inventor server accepts registration of participation in a predetermined event by the first user 10. Then, the event server confirms whether or not the first user 10 was present at the predetermined event at an event holding timing. An event holding timing is, for example, a date and time when an event is started.

If the inventor server confirms that the first user 10 was not present at the event at the event holding timing, the information processing apparatus 100 in the embodiment of the present disclosure performs the following process.

Though it is determined that the first user 10 was absent from the event if the first user 10 was not present at the event holding timing in the present embodiment, the determination on absence from the event may be performed in other methods.

The information processing apparatus 100 acquires position information 200 about the first user 10 at the event holding timing. If determining that the first user 10 was absent from the predetermined event at the event holding timing, the information processing apparatus 100 acquires the position information 200 from a corresponding user terminal 300. The position information 200 may be represented by latitude and longitude.

Next, the information processing apparatus 100 acquires first information which is information about the first user 10 at the event holding timing. For example, the information processing apparatus 100 may acquire health information 210 indicating the health condition of the first user 10 at the event holding timing, from the user terminal 300 as the first information.

Further, for example, the information processing apparatus 100 may acquire traffic information 220 indicating a traffic situation on a route from a point where the first user 10 was present to the venue of the predetermined event at the event holding timing, from a traffic information server 310 as the first information.

Further, for example, the information processing apparatus 100 may acquire weather information 230 indicating weather at the point where the first user 10 was present at the event holding timing, from a weather information server 320 as the first information.

Further, for example, the information processing apparatus 100 may acquire schedule information 240 indicating a schedule of the first user 10 at the event holding timing, from a schedule information server 330 as the first information.

Then, based on the first information and the position information 200 about the first user 10 at the event holding timing that have been acquired, the information processing apparatus 100 determines whether the reason for the first user 10 having been absent from the predetermined event is a force majeure reason or not. A specific method for the information processing apparatus 100 to determine whether the reason for the first user 10 having been absent from the predetermined event is a force majeure reason or not will be described later.

If determining that the reason for the first user 10 having been absent from the predetermined event is a force majeure reason, the information processing apparatus 100 selects the first user 10 as a follow-up target. Here, follow-up includes storing a target user and continuing to transmit notifications of events and the like to the target user. Further, selecting a user as a follow-up target includes storing the target user as a target of transmitting the notifications of events and the like.

If determining that the reason for the first user 10 having been absent from the predetermined event is a force majeure reason, the information processing apparatus 100 determines that the first user 10 was absent though he/she was interested in the predetermined event. Then, the information processing apparatus 100 selects the first user 10 as a target of continuing transmission of notifications of events and the like that are the same as or similar to the predetermined event.

The information processing apparatus 100 may notify the inventor server that the first user 10 has been selected as a follow-up target.

Thus, the information processing apparatus 100 acquires the position information 200 or the health condition of the first user 10, the traffic situation on the movement route of the first user 10 to the venue, the weather at the place where the first user 10 was located, and information about the schedule of the first user 10 and the like at the event holding timing of the predetermined event. Then, the information processing apparatus 100 determines whether the reason for the first user 10 having been absent from the predetermined event is a force majeure reason or not based on at least one of the above plurality of pieces of information. Then, if the reason for the first user 10 having been absent from the predetermined event is a force majeure reason, the information processing apparatus 100 selects the first user 10 as a follow-up target. Thereby, the information processing apparatus 100 can follow up the user who was absent from the predetermined event though he/she was interested in the predetermined event.

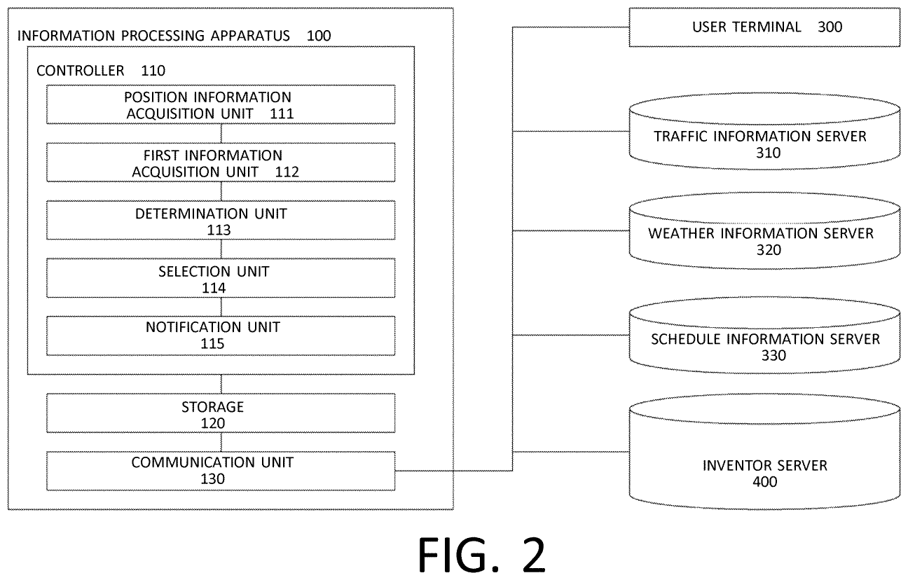

Next, each component constituting a system will be described in detail. FIG. 2 is a diagram illustrating the components included in the system, the system including the information processing apparatus 100 according to the embodiment.

The information processing apparatus 100 according to the present embodiment is provided with a controller 110, a storage 120, and a communication unit 130. The information processing apparatus 100 performs wireless communication with the user terminal 300, the traffic information server 310, the weather information server 320, and the schedule information server 330 to acquire the position information 200 and the first information about the first user 10. Further, the information processing apparatus 100 determines whether or not to select the first user 10 as a follow-up target, and, in the case of selecting the first user 10 as a follow-up target, performs communication with an inventor server 400 to notify the inventor server 400 thereof.

The controller 110 is realized with a processor such as a CPU (central processing unit) or a GPU (graphics processing unit) and a memory. The controller 110 is provided with a position information acquisition unit 111, a first information acquisition unit 112, a determination unit 113, a selection unit 114, and a notification unit 115 as functional modules. These functional modules may be realized by performing a program by the controller 110.

The position information acquisition unit 111 communicates with the user terminal 300 via the communication unit 130 to acquire the position information 200 about the first user 10 at the event holding timing. That is, the position information acquisition unit 111 acquires information about a place the first user 10 actually stayed at the event holding timing. For example, the position information acquisition unit 111 may acquire information corresponding to the time of the event holding timing from a log of the position information 200 about the first user 10 stored in the user terminal 300. The position information acquisition unit 111 communicates with the user terminal 300 via the communication unit 130.

The first information acquisition unit 112 acquires the first information, which is information about the first user 10 at the event holding timing, from various kinds of servers. Specifically, the first information acquisition unit 112 may acquire the health information 210, which is information about the health condition of the first user 10 at the event holding timing, from the user terminal 300. Further, the first information acquisition unit 112 may acquire the traffic information 220 indicating the traffic situation on the route from the point where the first user 10 was present to the venue of the predetermined event at the event holding timing, from the traffic information server 310.

Further, the first information acquisition unit 112 may acquire the weather information 230 indicating the weather at the point where the first user 10 was present at the event holding timing, from the weather information server 320. Further, the first information acquisition unit 112 may acquire the schedule information 240 indicating the schedule of the first user 10 at the event holding timing, from the schedule information server 330. The first information acquisition unit 112 communicates with the user terminal 300, the traffic information server 310, the weather information server 320, and the schedule information server 330 via the communication unit 130.

Based on the position information 200 about the first user 10 at the event holding timing acquired by the position information acquisition unit 111 and the first information acquired by the first information acquisition unit 112, the determination unit 113 determines whether the reason for the first user 10 having been absent from the predetermined event is a force majeure reason or not. For example, if, when the first information acquisition unit 112 has acquired the health information 210, the position of the first user 10 at the event holding timing was at the home of the first user 10 or in any hospital, and the health condition of the first user 10 indicated by the health information 210 was lower than a predetermined level, then the determination unit 113 may determine that the reason for the first user 10 having been absent from the predetermined event is a force majeure reason.

Further, for example, if, when the first information acquisition unit 112 has acquired the traffic information 220, the traffic situation from the position of the first user 10 to the venue of the predetermined event was such a situation that it was difficult for the first user 10 to move to the venue at the event holding timing, then the determination unit 113 may determine that the reason for the first user having been absent from the predetermined event is a force majeure reason.

If the determination unit 113 determines that the reason for the first user 10 having been absent from the predetermined event is a force majeure reason, the selection unit 114 selects the first user 10 as a follow-up target. That is, if the determination unit 113 determines that the reason for the first user 10 having been absent from the predetermined event is a force majeure reason, the selection unit 114 may cause the storage 120 to store the first user 10 as a follow-up target.

If the selection unit 114 selects the first user 10 as a follow-up target, the notification unit 115 notifies the inventor server 400 that the first user 10 has been selected as a follow-up target. The notification unit 115 communicates with the inventor server 400 via the communication unit 130.

The storage 120 includes a main memory such as a RAM or a ROM, and auxiliary storage devices such as an EPROM, a hard disk drive, and a removable medium. In an auxiliary storage device, an operating system (OS), various kinds of programs, various kinds of tables and the like are stored. By performing a program stored therein, each function of each unit of the controller 110 that meets a predetermined purpose can be realized. A part or all of the functions may be realized with a hardware circuit like an ASIC and an FPGA.

The storage 120 stores data and the like used or generated by a process performed by the controller 110.

The communication unit 130 includes a communication circuit for performing wireless communication. The communication unit 130 may be, for example, a communication circuit for performing wireless communication using 4G (4th generation) or may be a communication circuit for performing wireless communication using 5G (5th generation). Further, the communication unit 130 may be a communication circuit for performing wireless communication using LTE (Long Term Evolution) or may be a communication circuit for performing communication using LPWA (Low Power Wide Area). Further, the communication unit 130 may be a communication circuit for performing wireless communication using Wi-Fi®.

Next, the apparatuses other than the information processing apparatus 100 will be described.

The user terminal 300 is, for example, a wearable device. Specifically, the user terminal 300 may be, for example, a smartwatch and the like. Or alternatively, the user terminal 300 may be a smartphone, a tablet terminal, or the like. The user terminal 300 is provided with a GPS (global positioning system) and the like and records the position information 200 about the first user 10 who carries the user terminal 300. Further, the user terminal 300 is provided with a thermal sensor, a heart rate sensor, a blood pressure sensor, or a blood sugar level sensor, and the like to measure the health information 210 about the health condition of the first user 10 in time series.

The traffic information server 310 is configured to be capable of providing information about the route from the position of the first user 10 at the event holding timing to the venue of the predetermined event, and the traffic information 220 which is the situation of traffic on the route at the event holding timing. The traffic information server 310 may be a cloud server, or may be a single server apparatus.

The weather information server 320 is configured to be capable of providing the weather information 230, which is information about the weather at the position of the first user 10 at the event holding timing. The weather information server 320 is realized with a storage apparatus such as a server. The weather information server 320 may be a cloud server, or may be a server realized with one storage apparatus.

The schedule information server 330 is configured to be capable of providing the schedule information 240, which is information about the schedule of the first user 10 at the event holding timing. The schedule information server 330 is realized with a storage apparatus such as a server. The schedule information server 330 may be a cloud server or may be a server realized with one storage apparatus.

The inventor server 400 transmits a notification of holding the predetermined event to the first user 10 based on attribute information and the like about the first user 10. Further, the inventor server 400 accepts registration of participation in the predetermined event by the first user 10. Further, the inventor server 400 follows up the first user 10 if a predetermined condition is satisfied. Here, follow-up includes the inventor server 400 storing the information about the first user 10 and transmitting information about events that are the same or similar to the predetermined event to the first user 10. Further, selecting the first user 10 as a follow-up target includes the inventor server 400 storing the information about the first user 10. The inventor server 400 is a specific example of an inventor.

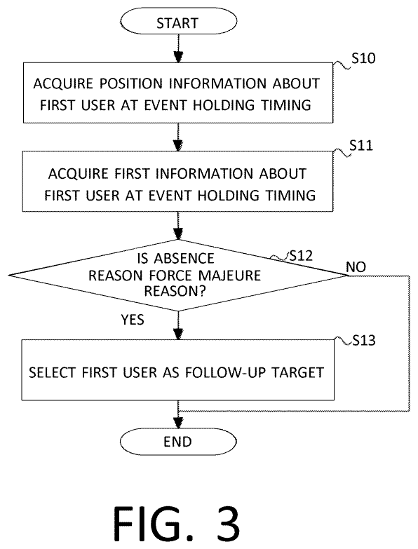

Next, specific content of the process performed by the information processing apparatus 100 will be described. FIG. 3 is a flowchart of the process performed by the controller 110 of the information processing apparatus 100 according to the embodiment.

It is assumed that, before the process illustrated in FIG. 3 is performed, the inventor server 400 accepts registration of participation in the predetermined event by the first user 10. Then, the inventor server 400 confirms that the first user 10 was absent from the predetermined event on the date and time of the predetermined event. The information processing apparatus 100 receives a notification that the first user 10 was absent from the predetermined event, from the inventor server 400. The process illustrated in FIG. 3 is started when the information processing apparatus 100 receives the notification.

First, at step S10, the position information acquisition unit 111 acquires the position information 200 indicating the position of the first user 10 at the event holding timing. The position information acquisition unit 111 communicates with the user terminal 300 via the communication unit 130 to acquire the position information 200 about the first user 10 at the event holding timing. Specifically, the position information acquisition unit 111 refers to the log of position information 200 about the first user 10 recorded in the user terminal 300 to acquire the position information 200 corresponding to the event holding timing.

Next, at step S11, the first information acquisition unit 112 acquires the first information corresponding to the first user 10. Specifically, the first information acquisition unit 112 acquires the health information 210 indicating the health condition of the first user 10 at the event holding timing, from the user terminal 300. Further, the first information acquisition unit 112 acquires the traffic information 220 indicating the traffic situation on the route from the position of the first user 10 to the venue of the predetermined event at the event holding timing, from the traffic information server 310.

Further, the first information acquisition unit 112 acquires the weather information 230 indicating the weather around the position of the first user 10 at the event holding timing, from the weather information server 320. Further, the first information acquisition unit 112 acquires the schedule information 240 indicating the schedule of the first user 10 at the event holding timing, from the schedule information server 330. The first information acquisition unit 112 may acquire one piece of information or may acquire a plurality of pieces of information, from the above pieces of information.

Next, at step S12, the determination unit 113 determines whether the reason for the first user 10 having been absent from the predetermined event is a force majeure reason or not. If the determination unit 113 determines that the reason for the first user 10 having been absent from the predetermined event is a force majeure reason, a positive determination is made at this step.

If a positive determination is made at this step, the process transitions to step S13.

If a negative determination is made at this step, the process ends.

If the process transitions to step S13, the selection unit 114 selects the first user 10 as a follow-up target. The selection unit 114 may cause the storage 120 to store that the first user 10 has been selected as a follow-up target.

Further, the notification unit 115 of the information processing apparatus 100 notifies the inventor server 400 that the first user 10 has been selected as a follow-up target. The notification unit 115 communicates with the inventor server 400 via the communication unit 130 to perform the notification.

Next, details of the process for the controller 110 to determine whether the absence reason of the first user 10 is a force majeure reason or not will be described.

As described before, whether the absence reason of the first user 10 is a force majeure reason or not can be determined based on the health condition of the first user 10, the traffic situation for movement, and the weather situation.

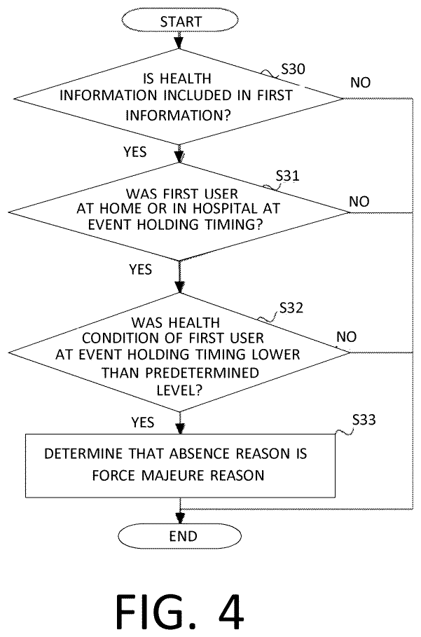

First, a process for the controller 110 to determine whether the absence reason of the first user 10 is a force majeure reason or not based on the health information 210 will be described. FIG. 4 is a flowchart of the process for making a determination on the absence reason based on the health information 210, which is performed by the controller 110 of the information processing apparatus 100 according to the embodiment. The process illustrated in FIG. 4 is performed at step S12 of FIG. 3.

First, at step S30, the determination unit 113 determines whether the health information 210 is included in the first information acquired by the first information acquisition unit 112 or not. If the determination unit 113 determines that the health information 210 is included in the first information acquired by the first information acquisition unit 112, a positive determination is made at this step.

If a positive determination is made at this step, the process transitions to step S31.

If a negative determination is made at this step, the process ends.

If the process transitions to step S31, the determination unit 113 determines whether or not the first user 10 was at his home or in any hospital at the event holding timing. The determination unit 113 may acquire the position information 200 about the first user 10 at the event holding timing, from the user terminal 300 and determine whether or not latitude/longitude information indicated by the acquired position information 200 corresponds to latitude/longitude information about a place registered as the home of the first user 10 or any hospital.

If the determination unit 113 determines that the first user 10 was at his home or in any hospital, a positive determination is made at this step.

If a positive determination is made at this step, the process transitions to step S32.

If a negative determination is made at this step, the process ends.

If the process transitions to step S32, the determination unit 113 determines whether the health condition of the first user 10 at the event holding timing was lower than the predetermined level or not. The determination unit 113 refers to the health information 210 about the first user 10 acquired by the first information acquisition unit 112. Then, the determination unit 113 may determine whether a value indicating the health condition of the first user 10 at the event holding timing is lower than a predetermine value or not. Or alternatively, the determination unit 113 may determine whether a value indicating an unhealthy condition of the first user 10 at the event holding timing is higher than a predetermine value or not.

If the determination unit 113 determines that the health condition of the first user 10 at the event holding timing is lower than the predetermined level, a positive determination is made at this step.

If a positive determination is made at this step, the process transitions to step S33.

If a negative determination is made at this step, the process ends.

If the process transitions to step S33, the determination unit 113 determines that the reason for the first user 10 having been absent from the predetermined event is a force majeure reason. The determination unit 113 determines that the first user 10 was sick or in a bad condition at the event holding timing, and determines that the first user 10 was absent from the predetermined event not intentionally but unwillingly.

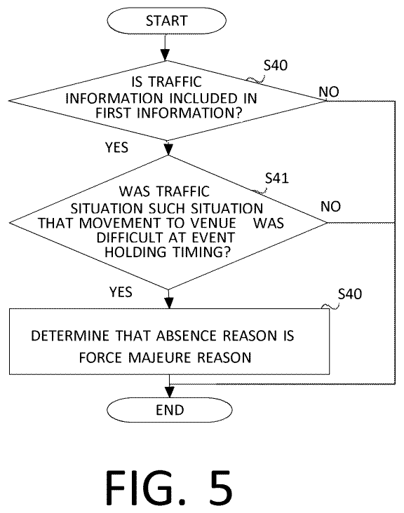

Next, a process for the controller 110 to determine whether the absence reason of the first user 10 is a force majeure reason or not based on the traffic information 220 will be described. FIG. 5 is a flowchart of the process for making a determination on the absence reason based on the traffic information 220, which is performed by the controller 110 of the information processing apparatus 100 according to the embodiment. The process illustrated in FIG. 5 is performed at step S12 of FIG. 3. Specifically, the process illustrated in FIG. 5 is performed continuously after the process illustrated in FIG. 4 is performed at step S12.

First, at step S40, the determination unit 113 determines whether the traffic information 220 is included in the first information acquired by the first information acquisition unit 112 or not. If the determination unit 113 determines that the traffic information 220 is included in the first information acquired by the first information acquisition unit 112, a positive determination is made at this step.

If a positive determination is made at this step, the process transitions to step S41.

If a negative determination is made at this step, the process ends.

If the process transitions to step S41, the determination unit 113 determines whether or not the traffic situation on the route from the position of the first user 10 to the venue of the predetermined event was such a situation that movement of the first user 10 was difficult at the event holding timing. The determination unit 113 acquires the traffic information 220 indicating the traffic situation on the route from the position indicated by the position information 200 about the first user 10 to the venue of the predetermined event at the event holding timing, from the traffic information server 310. If the traffic situation indicated by the acquired traffic information 220 is suspension of public traffic transportation on the route, a road traffic jam on the route, road closure on the route, or the like, the determination unit 113 determines that the traffic situation was such a situation that movement of the first user 10 was difficult.

If the determination unit 113 determines that the traffic situation on the route from the position of the first user 10 to the venue of the predetermined event was such a situation that movement of the first user 10 was difficult at the event holding timing, a positive determination is made at this step.

If a positive determination is made at this step, the process transitions to step S42.

If a negative determination is made at this step, the process ends.

If the process transitions to step S42, the determination unit 113 determines that the reason for the first user 10 having been absent from the predetermined event is a force majeure reason. The determination unit 113 determines that it was difficult for the first user 10 to move to the venue of the predetermined event at the event holding timing. In this case, the determination unit 113 determines that the first user 10 was absent from the predetermined event not intentionally but unwillingly.

Though it is determined whether the reason for the first user 10 having been absent from the predetermined event is a force majeure reason or not based on the health information 210 or the traffic information 220 in FIGS. 4 and 5, respectively, information used for the determination is not limited to the health information 210 and the traffic information 220. For example, the information processing apparatus 100 may perform the determination based on the weather information 230, the schedule information 240, or the like. A process described below may be performed continuously after the process of FIG. 4 or 5.

For example, the determination unit 113 determines whether the weather information 230 indicating the weather situation around the position of the first user 10 at the event holding timing of the predetermined event is included in the first information or not. Then, if determining that the weather information 230 indicating the weather situation around the position of the first user 10 at the event holding timing of the predetermined event is included in the first information, the determination unit 113 performs the following determination.

If determining that the weather situation around the position of the first user 10 was such a situation that it was difficult for the first user 10 to move to the event venue at the event holding timing of the predetermined event, the determination unit 113 determines that the reason for the absence from the predetermined event is a force majeure reason. The situation that it was difficult for the first user 10 to move to the event venue is, for example, heavy rain, storm, strong wind, lightning, hail, tornado, or the like. The determination unit 113 performs the above determination by referring to the weather information 230.

The determination unit 113 determines that it was difficult for the first user 10 to move to the venue of the predetermined event at the event holding timing. In this case, the determination unit 113 determines that the first user 10 was absent from the predetermined event not intentionally but unwillingly.

Further, for example, the determination unit 113 determines whether the schedule information 240 about work of the first user 10 at the event holding timing of the predetermined event is included in the first information or not. If determining that the schedule information 240 about the work of the first user 10 at the event holding timing of the predetermined event is included in the first information, the determination unit 113 performs the following determination.

If determining that the work of the first user 10 was scheduled at the event holding timing of the predetermined event, and the position of the first user 10 was at a place related to the scheduled work, then the determination unit 113 determines that the reason for the absence from the predetermined event is a force majeure reason. The position of the first user 10 being at the place related to the scheduled work may mean that latitude/longitude information about the position registered as the place related to the scheduled work and latitude/longitude information indicated by the position information 200 about the first user 10 at the event holding timing almost correspond to each other.

The determination unit 113 determines that, because of unavoidable work at the event holding timing, the first user 10 was absent from the predetermined event even though he/she was interested in the predetermined event. In this case, the determination unit 113 determines that the first user 10 was absent from the predetermined event not intentionally but unwillingly.

As described above, the information processing apparatus 100 determines whether the reason for the first user 10 having been absent from the predetermined event is a force majeure reason or not based on the position information 200 about the first user 10 and the first information at the event holding timing. Thereby, it is possible to extract the first user 10 who was unwillingly absent from the predetermined event even though he/she was interested in the predetermined event. Then, if it is determined that the reason for the first user 10 having been absent from the predetermined event is a force majeure reason, the first user 10 is selected as a follow-up target. Thereby, it is possible to continue to perform transmission of notifications about other events that are the same as or similar to the predetermined event, and the like, and secure the first user 10 as a potential customer.

### Modifications

The above embodiments are mere examples, and the present disclosure can be appropriately changed and implemented within a range not departing from the spirit thereof.

For example, the processes and means described in the present disclosure can be freely combined and implemented as far as technical contradiction does not occur.

Further, the processing described as being performed by one device may be shared and performed by a plurality of devices. Alternatively, the processing described as being performed by different devices may be performed by one device. In the computer system, it is possible to flexibly change what kind of hardware configuration (server configuration) each function is realized.

The present disclosure can also be realized by supplying a computer program implementing the functions described in the above embodiment to a computer, and one or more processors included in the computer read out and perform the program. Such computer programs may be provided to a computer by a non-transitory computer-readable storage medium connectable to a system bus of the computer, or may be provided to the computer over a network. A non-transitory computer-readable storage medium includes, for example, any type of disk, such as a magnetic disk (floppy disk, hard disk drive (HDD), etc.), an optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. An information processing apparatus comprising a controller, the controller comprising at least one processor configured to perform:
acquiring position information about a first user, the first user having been absent from a predetermined event at an event holding timing, which is a date and time of the predetermined event having been held;
acquiring first information that is information at the event holding timing different from the position information about the first user and is information related to the first user at the event holding timing;
determining whether a reason for the first user having been absent from the predetermined event is a force majeure reason or not based on the position information and the first information; and
selecting the first user as a follow-up target if the absence reason is determined to be a force majeure reason.

2. The information processing apparatus according to claim 1, wherein
the controller notifies an inventor that the first user has been selected as the follow-up target, the inventor being an apparatus for inviting a plurality of users to the predetermined event.

3. The information processing apparatus according to claim 1, wherein
the first information includes at least any of:
(i) health information indicating a health condition of the first user at the event holding timing;
(ii) traffic information indicating a traffic situation on a route from a position of the first user to a venue of the predetermined event at the event holding timing;
(iii) weather information indicating a weather situation around the position of the first user at the event holding timing; and
(iv) schedule information about a schedule of the first user at the event holding timing.

4. The information processing apparatus according to claim 3, wherein
if the first information includes (i) the health information indicating the health condition of the first user at the event holding timing, the position of the first user is at a home of the first user or in any hospital at the event holding timing, and the health condition of the first user is lower than a predetermined level, then the controller determines that the reason for the first user having been absent from the predetermined event is a force majeure reason.

5. The information processing apparatus according to claim 3, wherein
if the first information includes (ii) the traffic information at the event holding timing, and the traffic situation on the route from the position of the first user to the venue of the predetermined event is such a situation that it is difficult for the first user to move to the venue at the event holding timing, then the controller determines that the reason for the first user having been absent from the predetermined event is a force majeure reason.
